(19) United States
(12) Patent Application Publication
(10) Pub. No.: US 2015/0119520 A1
(43) Pub. Date: Apr. 30, 2015

(54) THERMATROPIC PARTICLES, METHOD FOR THE PRODUCTION AND USE THEREOF, AND DOPED POLYMERS CONTAINING SAME

(71) Applicants: Fraunhofer-Gesewllschaft Zur Forderung Der Angewandten Forschung E.V., Munchen (DE); Quarzwerke GmbH, Frechen (DE)

(72) Inventors: Arno Seeboth, Berlin (DE); Ralf Ruhmann, Berlin (DE); Olaf Muhling, Berlin (DE); Jorg-Ulrich Zilles, Koln (DE); Dirk Kruber, Alfter (DE)

(21) Appl. No.: 14/390,913

(22) PCT Filed: Mar. 18, 2013
(86) PCT No.: PCT/EP2013/055554

§ 371 Date: Oct. 6, 2014

(30) Foreign Application Priority Data
Apr. 13, 2012 (DE) 10 2012 007 438.7

(51) Int. Cl. C09D 5/26; C09D 7/12; C09D 133/08; C08F 265/06; C09D 123/06

(52) U.S. Cl. CPC C09D 5/26; C08F 265/06; C09D 123/06; C09D 133/08; C09D 7/1291
USPC 524/504; 525/309; 428/402

(57) ABSTRACT

The invention relates to a method for producing thermatropic particles for doping polymer matrices, and to such doped polymers. The doped polymer matrices according to the invention can be used as sun protection, in the form of varnishes, coatings, resins, thermosets, or thermoplastics, for example.

The invention relates to a process for the preparation of thermotropic particles for the doping of polymer matrices, and to such doped polymers. Doped polymer matrices according to the invention are employed as sun protection, for example, in the form of paints, coatings, resins, thermosets or thermoplastics.

The protection against overheating in buildings is still mainly achieved by conventional mechanical shading. The average annual consumption of energy in buildings for cooling thereof worldwide already almost exceeds the adequate energy consumption for heating them. The increasing use of glass facades in architecture, including the use of organic glasses, accelerates this process increasingly. The excellent thermal insulation capabilities of today's glass facades, whereby the buildings are kept from cooling down in winter, have an energetically counter-productive effect in warm seasons. Electric power for cooling is needed. An optimization of the energy balance is required to avoid increasing thermal stress in the cities. Accordingly, buildings must be planned so that passive cooling takes place, rather than provide them with electric air conditioning systems.

New techniques, such as gasochromism, but also especially electrochromism, so far could not establish themselves in the market. Even more than a decade after their introduction into the market, they still play a niche role. The main reason for this, in addition to economic aspects, is still a number of unresolved technological issues and subsequent high maintenance costs.

The use of thermotropic hydrogels (Affinity Co. Ltd.) or polymer blends (Interpane) for sun protection has been discussed for decades. Both types of materials, which use phase separation as the physical effect, could not reach a breakthrough in the market. The use of phase change materials (PCM) in capsule form for the purpose of heat reflection/sun protection and their incorporation into plastics also belong to the familiar prior art. Thus, WO 93/15625 A1 describes thermal insulation in clothing and footwear, EP 1 321 182 B1 describes the utilization of latent heat storage for temperature control, US 2003/0109910 A1 describes insulating layers for clothing and gloves or mittens, and WO 94/02257 A2 describes the use of PCM for clothing and medical-therapeutic purposes. However, these documents do not provide clear instructions for a practice-relevant implementation of thermally controllable optical effects that are suitable for adaptive sun protection.

The application of thermotropic monomers of an aliphatic compound of general formula CₙHₙ₊₂, where n=5 to 30, in a concentration of from 0.5 to 10% by weight in a photocuring polymer to influence the temperature-dependent refractive index as proposed in EP 1 258 504 B1 could not reach marketability either. The publication “Thermotropic and Thermochromic Polymer Based Materials for Adaptive Solar Control (Solar Control. Materials 2010; 3 (12): 5143-5168) is a current overview of the development of materials for sun protection. Thermotropic polyolefin films based on a core of an alkane and a shell of vinyl monomers are being discussed. Stability during the extrusion process is to be improved by the use of an outer shell (multiwall).

In addition to unresolved technological issues, reaction mechanisms that are still poorly understood even today in the thermotropic systems employed, including competing chemical reactions, phase separations in gels and blends, phase transitions in PCM, are certainly major reasons why a broad market introduction has been prevented.

All existing systems involve migration effects of the optically active material in the polymer matrix, have insufficient chemical and mechanical stability during the extrusion process, have a poor adhesion, which results in adhesion failures, are not light stable, or undergo chemical degradation processes, in particular, in the application of biological polymers, such as starch mixed derivatives. Extrusion-stable capsules with optically switchable properties for the reproducible preparation of thermotropic sun protection films do not yet exist.

Therefore, the invention is based on the object to develop thermotropic particles whose specific surface structure, temperature-dependent translucency, dopability and extrusion stability in polymer matrices enable them to be used for sun protection. Depending on the temperature, the translucency of the plastic doped with the thermotropic particles is reversibly switched.

This object is achieved by the inventive method with the features of claim 1, the thermotropic particles with the features of claim 6 and the doped polymers with the features of claim 9. Claim 13 provides the use of the doped polymers according to the invention. The further dependent claims indicate advantageous further embodiments.

According to the invention, a process for the preparation of thermotropic particles for doping polymer matrices is provided, comprising the steps of:
a. providing an organic phase containing at least one monomer suitable for polymer formation, and at least one organic solvent;
b. providing an aqueous phase containing at least one surfactant and/or at least one surface-active compound;
c. preparing a dispersion of the aqueous and organic phases by mixing the two phases;
d. optionally adding at least one initiator to start the polymer formation;
e. 1st stage of polymer formation to form a substantially spherical particle core;
f. 2nd stage of polymer formation to incorporate anchor groups deviating from the spherical arrangement in the surface of the particle core; and
g. isolating the thermotropic particles.

“Polymer formation” as used in the context of the present invention refers to polymerizations, especially free-radical and ionic polymerizations, as well as polyadditions or polycondensations. The term “anchor groups deviating from the spherical arrangement in the surface of the particle core” means that the particle core has a surface deviating from its spherical arrangement, or obtains such surface from step f., because of the incorporation of anchor groups on its surface.

The following known physicochemical effects for purposefully influencing the material properties are essentially recurred to: i) optical anisotropy in polymeric networks from partial cross-linking (Adv. Mater. 1992, 4, No. 10, 679), ii) effect of molecular weight on temperature-controlled translucency (Adv. Mater. 1996, 8, No. 5, 408), and iii) intermolecular dispersive or polar interaction between surface-active agents (surfactants) and the resulting optical effect in polymeric structures (Colloid Polym Sci 272: 1151, 1994).

The integrating interaction of optically anisotropic networks because of different degrees of crosslinking, use of different molecular weights or different polymer structures in the system and the utilization of intermolecular interaction in molecules with at least dimeric structure open up new solution strategies for material development. This is not about the optimization of known technical processes. This approach represents a new strategy towards the development of functional materials.

The particles can be prepared by free-radical or ionic polymerization, polycondensation or polyaddition. The initial reaction is carried out with conventional components, such as, preferably, azo-bis-(isobutyronitrile), dibenzoyl peroxide, sodium peroxodisulfate, Lewis acids, such as AlCl₃, or butyl lithium. The size of the particles can be controlled either kinetically or thermodynamically. The available technological parameters include the selected amplitude at a given frequency when using ultrasound, or the revolutions per minute when using a dissolver or Turrax device. The use of different ultrasonic heads or dispersing tools based on the rotator-stator principle open up additional possibilities to influence the particle size. The selection and concentration of the surface-active agent serves as the primary working method for setting the resulting particle size. If the surface-active agent is used as a surfactant, as in the case of emulsion polymerization, then its concentration is above the critical micelle concentration, cmc. The surface-active substances are also suitable to specifically affect the surface structure both geometrically and in terms of surface chemistry. In this case, the concentration may also be below the cmc, so that no micelles can be formed. Accordingly, the molecule does not act as an aggregated structural complex in the system, but the individual molecule determines its physicochemical properties. Particle sizes of from 100 nm to 8 μm, preferably from 250 nm to 450 nm, are sought.

The ratio of the organic to the aqueous phase in the first polymerization stage is preferably within a range of from 0.6:6.3 to 1.5:5. Generally, however, all the mixing ratios are applicable for which a stable system, i.e. one capable of forming polymeric network structures, exists in the reaction medium. Ratios of 1:9 or 9:1 may also be expedient. The degree of polymerization is determined by the mutual ratio of individual components in the organic and aqueous phases. The first polymerization stage is initiated by the addition of the initiator medium. The chosen temperature and reaction time are more parameters to determine the degree of crosslinking and the particle size.

In the second polymerization stage, addition of monomer components is again performed. These may be either identical with the components in the first stage, or have a different structure. In the first stage, monomers with an aromatic basic structure, in addition to monomers with an aliphatic basic structure, are preferably used, which has advantageous effects on the design and temperature-dependent variation of the refractive index of the particles. In the second stage, monomers the polymerization of which can be controlled particularly well by technical parameters, such as temperature and time, are advantageously used. Part of the monomers need not be necessarily reacted, but remains integrated as a monomer unit in the polymer network. The remaining reactive groups of the monomer are capable of altering the surface geometry of the particle and are also capable of undergoing consecutive reactions with surface-active substances. When further surface-active agents are added, their concentration remains below the cmc. Thus, the build-up of a closed shell around the already existing pre-particle in the reaction medium is prevented. In this reaction step, the substance explicitly does not serve as a surfactant, but for the structural geometric and physicochemical change of the surface structure.

The reaction time for both stages is 30 minutes to 4 hours at a temperature of from 40° C. to 90° C. The yield of thermotropic particulate material is significantly higher than 90%. Significant deviations of the required reaction time and the yield can exist because of changed molarities and heat regulation.

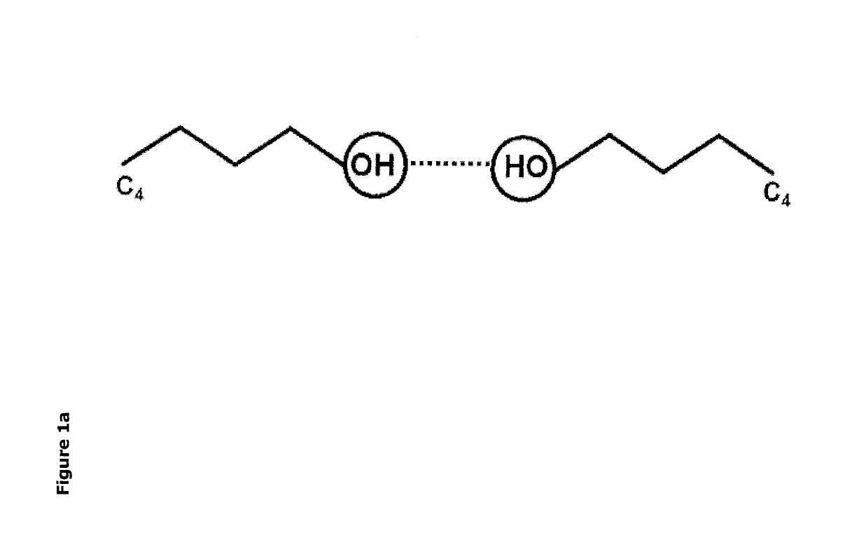

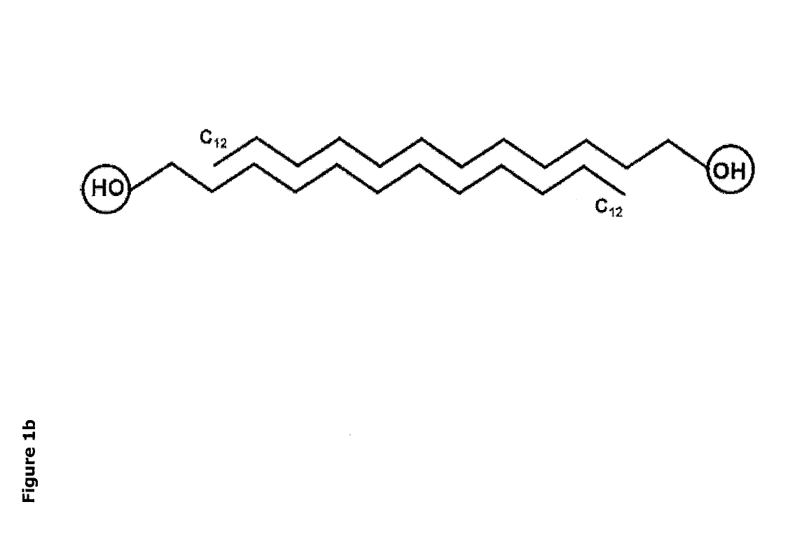

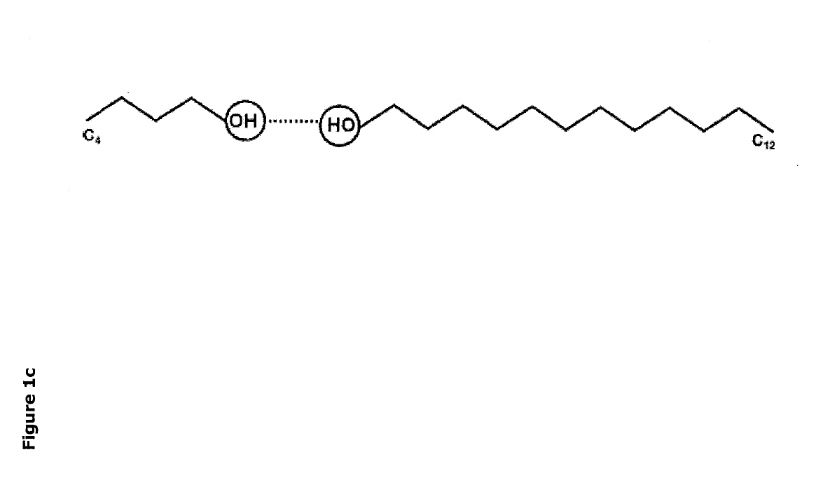

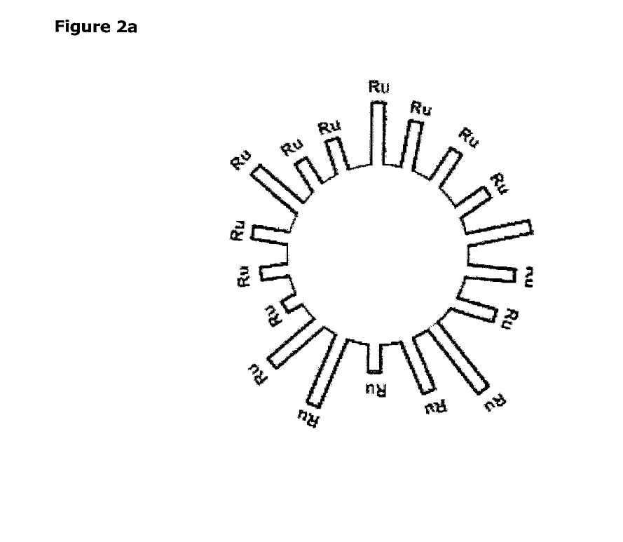

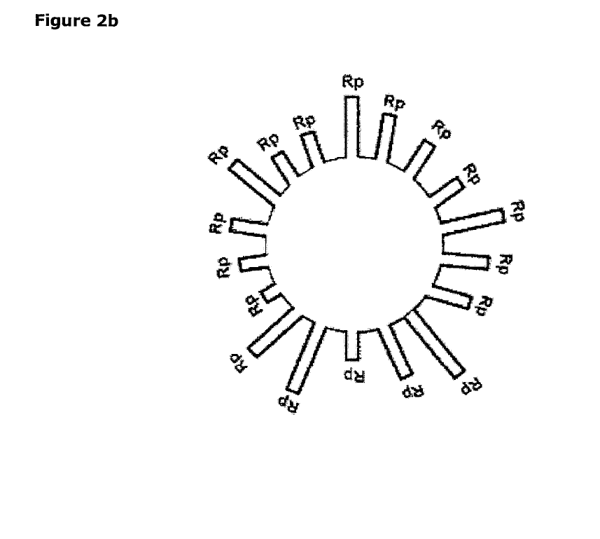

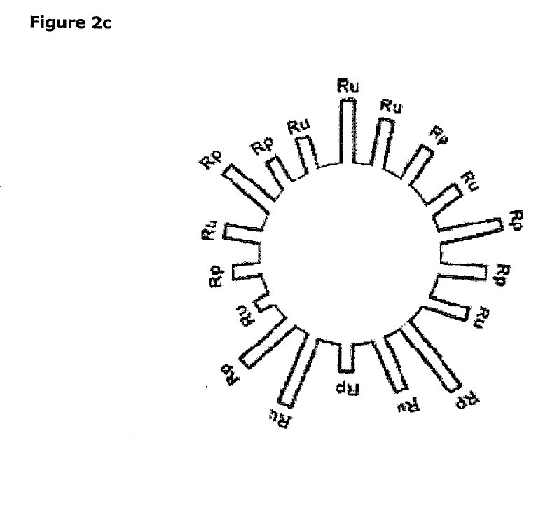

Besides the use of single molecules, dimers or molecular compounds of an even higher complexity are useful as surface-active agents. Homologous series of functionalized paraffin structures are especially suitable for this. Thus, short-chain alcohols, such as butanol, will interact intermolecularly, preferably via the polar alcohol group. The dispersive forces of the relatively short CH₂ chain are not strongly developed. The polar hydroxy groups of both molecules are bound by their mutual interaction, they are neutralized in the system. Now, the free valences of the dispersive CH₂ molecular fraction act outwardly. In such a case, the anchor groups R are preferably of a non-polar nature Rᵤ, as shown in FIG. 2a, and FIG. 1a (with hydroxy group —OH and four CH₂ units). Long-chain alcohols, such as lauryl or octadecyl alcohol, show a different behavior. Here, the pronounced dispersive forces can compete for interaction with the hydroxy functional group. The interaction takes place via the CH₂ structure, so that the hydroxy groups essentially determine the physicochemical behavior outwardly (FIG. 1b), and accordingly, the anchor groups are of a polar nature, Rₚ, FIG. 2b. For the skilled person, it is easily recognizable that this effect can be employed in many different variants. The combination of molecules having extremely different structures is possible, FIG. 1c. The most important ones are the variation of the CH₂ chain, the use of different functional groups, such as alcohol, amine, amide, sulfonate or acid groups, to each other in both intra- and intermolecular manner, or interaction of different functional groups. This is a design principle as perfected in the life sciences (Angew. Chem. 104, 1990, 1310). Thus, the particle may also dispose of polar Rₚ and non-polar Rᵤ, as shown in FIG. 2c. The functioning of the anchor groups can be realized already by a monomolecular structure. When the surface-active agents interact with the pre-particle, they can now act selectively via the polar functional group or the dispersive molecule portion.

Alternatively, or also in combination with low molecular weight compounds, polymeric substances, such as polyols or polyvinyl alcohol, may also be used as surface-active substances. However, if polymers with widely varying molecular weights of the same or similar structure, such as polyols, polyether polyol, polyester polyol, polyvinyl alcohol with different degrees of hydrolysis, are caused to interact in a self-orienting system, the translucency can be controlled in a temperature-dependant way. In this case, the effect can be based either on phase separation or on a phase transition in an anisotropic system; consequently, the refractive index of the overall system is changed in a manner visible to the eye.

The use of surface-active agents or surfactants in stage 1 or stage 2 decides whether the components are preferably incorporated in the network bulk, or are positioned on the surface. The integration in the bulk is aimed primarily to the immediate influence on the refractive index, while the positioning on the surface determines its physicochemical property.

With the control of the degree of crosslinking on the one hand and the deterministic integration of unreacted monomers in the particles on the other hand, another tool for the design of the particle and its surface is available. A relatively high degree of crosslinking and low proportion of residual monomers reduces the number of active chemical and steric sites. Ideally, the thermotropic final particle can be manufactured by the character of the pre-particles and of the surface-active agents, as well as their interaction. The isolation of the particles is effected by common technologies.

If a specific pH value is required for the polymerization, it can be set with the buffer solutions known for this purpose. As the polymerization initiator, there can be used, among others: dibenzoyl peroxide, sodium peroxodisulfate, azobis(isobutyronitrile) or HBF₄.

Preferably, the monomer is selected from the group of vinyl compounds, acrylates, diols, diamines, phenols, aldehydes, dicarboxylic acids, and mixtures thereof, in particular adipic acid, hexamethylenediamine, p-phenylenediamine, terephthalic acid, sebacic acid and derivatives thereof, lysine, arginine, histidine, aspartic acid, glutamic acid, bis(maleic imide), and derivatives, hydrazine and derivatives thereof, urea and its derivatives, styrene, vinyl chloride, vinyl acetate, alkyl vinyl ester, isopropenyl acetate, acrylonitrile, acrylic acid esters, methyl methacrylate, octadecyl acrylate, hydroxyethyl acrylate, allyl methacrylate, ethyl acrylate, and mixtures thereof.

The surfactants and/or surface-active compounds are preferably selected from the group consisting of alkylbenzenesulfonates, alkane sulfonates, such as sodium dodecyl sulfonate, fatty alcohol sulfonates, such as sodium laurylsulfonate, succinates, such as sodium 1,4-bis(2-ethylhexoxy)-1,4-dioxobutane-2-sulfonate, dodecylbenzylsulfonic acid, sulfobetaines, such as pyridinium propyl sulfobetaine, pyridinium hydroxy propyl sulfobetaine, lauryl sulfobetaine, dodecyl- and decylalkyl carboxylate, Na lauryl-glucose carboxylate, diols, triols, polyols, diamines, triamines, dicarboxylic acids, amino acids, butane diol, butyne diol, butene diol, n-butylamides, butenediamine, hexamethylene diamine, lauryl alcohol, decyl alcohol, tetradecyl alcohol, stearyl alcohol, stearylic acid, stearyl sulfonate, erucic acid, hexadecylamine, 1,16-hexadecyldiamine, polyols, such as Voranol P400 (molecular weight 400), Voranol CP 6055 (molecular weight 6000), Voranol RA 800 (molecular weight 280), polyethylene glycol 400, polyethylene glycol 800, amino-PEG acids, such as alpha-[3-(o-pyridoldisulfido)propanolamido]-omega-succinimide ester octa(ethylene glycol), or Bzl-O-dPEG(4)-COOH, HO-PEG(24)-CO-tBu, tBu-O2C-PEG(12)-COOH, methoxy polyethylene glycol, 4-nonylphenyl polyethylene glycol, polyvinyl alcohol, fully hydrolyzed PVA (molecular weight 70,000), fully hydrolyzed PVA (molecular weight 200,000), 98% hydrolyzed PVA (molecular weight 27,000, 88% hydrolyzed PVA (125,000), and mixtures thereof.

Voranol P400, Voranol CP and/or Voranol RA 800 are mixtures of multiradial polyethers consisting of polyethylene oxide and ethylene oxide.

The ratio between the organic and aqueous phases, based on the weight proportions, is preferably within a range of from 1:9 to 9:1, more preferably within a range of from 1.5 to 5.

According to the invention, thermotropic particles for doping a polymer matrix with a substantially spherical particle core and, arranged at the surface of the particle core, anchor groups deviating from the spherical configuration are also provided, wherein the polarity of the anchor groups and of the polymer matrix is substantially identical. A measure of this is the interfacial tension. The difference in the interfacial tension of the anchor group in comparison with the interfacial tension of the polymer matrix is preferably not more than 25 m/Nm, more preferably not more than 5 m/Nm. The values here include both the polar and dispersive components. The interfacial tension can be easily determined using a Krüss G40 (software BP21, K121, K122). The particles can be prepared by the process described above.

The particles according to the invention have a crosslinked polymer structure with thermotropic optical properties, wherein the surface of the particles, similar to a virus, is provided with anchoring groups. These anchor groups protruding from the spherical shape can have a hydrophobic and/or hydrophilic character.

Thus, according to the invention, the construction of a conventional capsule with a core and coat/shell is dispensed with. In addition, the spatial spherical geometry is disrupted by additional anchor groups with specific adhesion properties to the polymer matrix. In this case, the interaction between particles and matrix is based, as opposed to classical capsules, not only on chemical agents, but also on surface structural characteristics, which is a mechanism such as that used in the life sciences. Advantageously, the anchor groups can also be of very different structures. Thus, both polar and dispersive forces may be involved in the interaction between the particles and the matrix. Thus, migration effects can be counteracted selectively for the first time.

The thermotropic particle consists of a crosslinked polymer. The crosslinking can have different degrees, whereby the elasticity of the thermotropic material can be selectively influenced. The crosslinking need not be quantitative. Part of the monomers may remain unreacted, thus specifically affecting the mechanical and optical properties. The novel elastic properties of the particles allow their use in extrusion technology for the processing of thermoplastic materials. In addition, the thermotropic particulate matter may also be employed in thermosets, resin systems, paints/coatings, casting technology, or in a sol-gel method.

The reversible switching from an optically clear to a translucent state as the temperature increases is due to a change of the refractive index η_{Dp} of the particle; in contrast, the refractive index of the polymer matrix, n_{Dm}, remains largely constant. If both refractive indices are almost identical at room temperature, a transparent, clear state is reached, which is changed to a translucent, turbid state as the temperature-controlled refractive index of the particle decreases. With appropriate tuning of the temperature-dependent refractive index of the particle with respect to the refractive index of the matrix, a reversible switching behavior of turbid to clear, or turbid to clear to turbid, can also be adjusted. To the skilled person, it is readily apparent that all the possibilities of optical rules can be utilized here.

The thermotropic particles according to the invention can be doped into a polymer matrix in the form of a powder, compound or masterbatch. The doping level may preferably be from 0.2% by weight to 48% by weight, more preferably from 3% to 11%. When the temperature changes, the refractive index of the polymer matrix remains largely constant while the refractive index of the thermotropic particle changes. As a result, the translucency of the plastic changes, so that the material is suitable for adaptive sun protection; the thermotropic switching process is reversible. The material obtains a particularly efficiency with regard to its sun protection properties through the backscattering of a substantial part of the electromagnetic radiation.

The properties of the particle according to the invention enable it to be doped in a wide variety of matrices. These may be of an aliphatic, aromatic, hydrophilic or hydrophobic nature. Coatings, casting resins, thermosets or thermoplastics can be doped. The requirements on the final product determine the degree of doping, which can be from 0.5 to 35% by weight. For use in sun protection materials, a doping level of from 3 to 25% by weight is preferred. The incorporation of different thermotropic particles with different switching temperatures, two or more, in one polymeric matrix is possible, if necessary. The elasticity, caused by the absence of a quantitative polymerization reaction and the incorporation of monomers as well as the absence of a shell structure as in classical micro- or nanocapsules, enables the particles to be used in extrusion technology.

Using the following Figures and Examples, the subject of the invention is to be further illustrated, without wishing to restrict it to the specific embodiments shown herein.

FIGS. 1 a), b) and c) show possible anchor groups and their interactions by way of schematic representations.

FIGS. 2 a), b) and c) schematically show thermotropic particles according to the invention with non-polar anchor groups (FIG. 2 a)), polar anchor groups (FIG. 2 b)) as well as a combination of polar and non-polar anchor groups (FIG. 2 c)).

### EXAMPLE 1

### Thermotropic Polymer Film

The organic phase consists of octadecyl acrylate, 1-octadecane and vinyl acetate, the proportion of octadecyl acrylate corresponding to a ratio of 7:2.5:0.5% by weight. In the aqueous phase, there are lauryl sulfobetaine, 1-butanol and 1-hexanol, and sodium hydrogensulfate as a pH buffer in a ratio of 0.8:48:48:3.2% by weight. The water content is greater than 96% by weight. Both phases are heated in a water bath at about 50° C. with stirring. An aqueous initiator solution with AIBN is prepared.

In the first stage, the aqueous and organic phases are combined, their mutual ratio being 4:1. Immediately thereafter, the mixture is treated with an Ultra-Turrax for 3 minutes at 17,000 rpm. The mixture is transferred to a flask and heated over 30 minutes from 50° C. to 80° C. with stirring. The flask is purged with nitrogen, and is equipped with a reflux condenser. After another 15 min, the addition of the sodium peroxodisulfate initiator solution takes place. The reaction mixture is briefly heated to 90° C. and then cooled back to 80° C. After a reaction time of 70 minutes, the second stage is started by the addition of a mixture of octadecyl acrylate: methyl methacrylate, 20:1, which was added dropwise, the temperature remaining unchanged. Subsequently, the stirring is continued for 85 min at constant 80° C. The reaction is complete, the solution is cooled to room temperature and allowed to stand overnight. The suspension can be filtered. The yield of the thermotropic particles is 82%. The particle size is generally in the range of 600 nm to 2 μm.

In the following step, the thermotropic particles are processed in a twin-screw extruder with polyethylene to form a compound. The particle content is 5.5% by weight. In a subsequent flat film extrusion process, a thermotropic polyethylene film of the type LD with a layer thickness of 155 μm is prepared.

With increasing temperature, the transparency is reduced. A reversible switching stroke of ΔT≈37% is achieved. The proportion of back radiation in the solar radiation is 18%.

The film is suitable for use as an adaptive sun protection. The temperature-controlled switching between the different translucent modes does not require any external power sources. The switching is effected by the input of solar radiation. The process is reversible.

### EXAMPLE 2

### Thermotropic Film

The organic phase consists of polyvinyl alcohol, octadecyl acrylate and 1-octadecane in a ratio of 0.8:7.5:2% by weight. In the aqueous phase, there are sodium 1,4-bis(ethylhexoxy)-1,4-dioxobutane-2-sulfonate, lauryl alcohol, 1-hexanol and citric acid/sodium hydroxide as a pH buffer in a ratio of 1.6:52.4:42:4% by weight. The water content is greater than 94% by weight. Both phases are heated in a water bath at about 50° C. with stirring. The further procedure is as in Example 1. The particle size is in the range of 500 nm to 2.3 μm.

In the following step, the thermotropic particles are processed in a twin-screw extruder with ethylene-butyl acrylate copolymer to give a compound. The particle content is 12.5% by weight. In a subsequent flat film extrusion method, a thermotropic film with a layer thickness of 190 μm is prepared.

With increasing temperature, the transparency is reduced. A reversible switching stroke of ΔT≈41% is achieved. The proportion of back radiation in the solar radiation is 23%.

The skilled person will appreciate that there are a variety of factors which may affect the thermotropic behavior of the plastic, which is doped with the particulate material. These include, among others, the tuning of the refractive index between the polymer matrix and the particles, the degree of doping, the particle size and its distribution, or the layer thickness of the plastic. The latter is 0.2 to 10 μm for a paint, 20 to 200 μm for a laminate sheet, 50 to 220 μm for an adhesive sheet, 200 μm to 2.5 cm for a web plate.

The wide range of variation of the thermotropic properties through technology influences such as the doping level, particle size and distribution or material selection of components allows a wide use for sun protection, including agricultural films. Temperature-controlled switching transitions in the range between 25° C. and 36° C. are preferred for smart windows in Europe, switching temperatures of 30° C. to 46° C. are preferred for countries further south. If thermotropic materials are used for overheating protection in solar panels, switching temperatures above 60° C., preferably at 80° C., are required.

For non-polar polymer matrices such as polyolefins, anchor groups also having a non-polar nature are preferred, CH₂ chains being more preferred. Polar anchor groups are correspondingly preferred for polar matrices. Suitable for this purpose are, for example, hydroxy, amine, carboxy, sulfonate, phosphate or anhydride groups. However, it should be explicitly noted that particles with both polar and non-polar anchor groups fulfill the function of adhesion to the polymer matrix, whether the latter is polar or non-polar. The decisive factors are the anchor groups that allow adhesion by physicochemical interaction.

Only when the polarity of the anchor groups may be set to substantially correspond to the polarity of the polymer matrix, the migration of the thermotropic particles can be successfully prevented. A physical parameter that serves this purpose is interfacial tension γ with its polar and dispersive (non-polar) fractions.

Thus, it is apparent that a specific polymer matrix structure also requires a specific surface area of the thermotropic particles. For non-polar polyolefin films, particles with a proportion of more than 90% non-polar anchor groups are advantageous. With increasing polarity of the polymer matrix, particles with a higher polar proportion must be used correspondingly. For example, if the ethylene-butyl acrylate copolymer (with about 12% acrylate) is employed as a polymer matrix, a particle with a higher polar proportion of about 20% is used; the non-polar fraction on the surface of the anchoring groups is correspondingly reduced to about 80%. In web plates of Plexiglas, particles with preferably up to 60% polar anchor groups on the surface are used. For coatings and thermosets, particles with polar anchor groups of about 60-70% and above 80% are used. For an epoxy resin of bisphenol and epichlorohydrin (hardener Araldite MY721, 2,2-dimethyl-4,4-methylene-bis(cyclohexylamine), the proportion of the polar anchor groups is about 92%, and that of the non-polar ones is about 8%. In the preparation of thermotropic paints by doping with the particles according to the invention, the reaction medium, which may be water-based or based on organic solvents, has an additional influence on the choice of the ratio between non-polar and polar anchor groups. For technological reasons, non-polar anchor groups in an aqueous medium, which is then evaporated, are preferred. Their proportion is above 50%, preferably from 78 to 99%. If particles having a high polar content are needed for thermotropic paint layers, a procedure in non-polar organic solvents, which are subsequently evaporated, is preferable.

1. A process for the preparation of thermotropic particles for doping polymer matrices is provided, comprising the steps of:
a. providing an organic phase containing at least one monomer suitable for polymer formation, and at least one organic solvent;
b. providing an aqueous phase containing at least one surfactant and/or at least one surface-active compound;
c. preparing a dispersion of the aqueous and organic phases by mixing the two phases;
d. optionally adding at least one initiator to start the polymer formation;
e. 1st stage of polymer formation to form a substantially spherical particle core;
f. 2nd stage of polymer formation to incorporate anchor groups deviating from the spherical arrangement in the surface of the particle core; and
g. isolating the thermotropic particles.

2. The process according to claim 1,
wherein said monomer is selected from the group of vinyl compounds, acrylates, diols, diamines, phenols, aldehydes, dicarboxylic acids, and mixtures thereof, in particular adipic acid, hexamethylenediamine, p-phenylenediamine, terephthalic acid, sebacic acid and derivatives thereof, lysine, arginine, histidine, aspartic acid, glutamic acid, bis(maleic imide), and derivatives, hydrazine and derivatives thereof, urea and its derivatives, styrene, vinyl chloride, vinyl acetate, alkyl vinyl ester, isopropenyl acetate, acrylonitrile, acrylic acid esters, methyl methacrylate, octadecyl acrylate, hydroxyethyl acrylate, allyl methacrylate, ethyl acrylate, and mixtures thereof.

3. The process according to claim 1, wherein said surfactants and/or surface-active compounds are selected from the group consisting of alkylbenzenesulfonates, alkane sulfonates, such as sodium dodecyl sulfonate, fatty alcohol sulfonates, such as sodium laurylsulfonate, succinates, such as sodium 1,4-bis(2-ethylhexoxy)-1,4-dioxobutane-2-sulfonate, dodecylbenzylsulfonic acid, sulfobetaines, such as pyridinium propyl sulfobetaine, pyridinium hydroxy propyl sulfobetaine, lauryl sulfobetaine, dodecyl- and decylalkyl carboxylate, Na lauryl-glucose carboxylate, diols, triols, polyols, diamines, triamines, dicarboxylic acids, amino acids, butane diol, butyne diol, butene diol, n-butylamides, butenediamine, hexamethylene diamine, lauryl alcohol, decyl alcohol, tetradecyl alcohol, stearyl alcohol, stearylic acid, stearyl sulfonate, erucic acid, hexadecylamine, 1,16-hexadecyldiamine, polyols, such as Voranol P400 (molecular weight 400), Voranol CP 6055 (molecular weight 6000), Voranol RA 800 (molecular weight 280), polyethylene glycol 400, polyethylene glycol 800, amino-PEG acids, such as alpha-[3-(o-pyridoldisulfido)propanolamido]-omega-succinimide ester octa(ethylene glycol), or Bzl-O-dPEG(4)-COOH, HO-PEG(24)-CO-tBu, tBu-O2C-PEG(12)-COOH, methoxy polyethylene glycol, 4-nonylphenyl polyethylene glycol, polyvinyl alcohol, fully hydrolyzed PVA (molecular weight 70,000), fully hydrolyzed PVA (molecular weight 200,000), 98% hydrolyzed PVA (molecular weight 27,000, 88% hydrolyzed PVA (125,000), and mixtures thereof.

4. The process according to claim 1, wherein the ratio of the organic to the aqueous phase, based on the weight proportions, is within a range of from 1:9 to 9:1, especially within a range of from 0.6:6.3 to 1.5:5.

5. The process according to claim 1, wherein the polymer formation is a free-radical polymerization, polyaddition or polycondensation.

6. Thermotropic particles for doping a polymer matrix with a substantially spherical particle core and, arranged at the surface of the particle core, anchor groups deviating from the spherical configuration, wherein the interfacial tension of the anchor groups (γ_{A}) differs from the interfacial tension of the polymer matrix (γ_{P}) by not more than 25 m/Nm, especially by not more than 5 m/Nm, and the particles can be prepared by the process according to any of the preceding claims.

7. Thermotropic particles according to claim 6, wherein said particles have diameters of from 100 nm to 2 μm, especially from 250 nm to 450 nm.

8. Thermotropic particles according to claim 6, wherein the thermotropic switching of the particles is reversible and takes place within a temperature range of from 25° C. to 80° C.

9. Doped polymers comprising a polymer matrix with thermotropic particles according to claim 6.

10. Doped polymers according to claim 9, wherein said polymer matrix contains from 0.2 to 48% by weight, especially from 3 to 25% by weight, of said thermotropic particles.

11. Doped polymers according to claim 9, wherein said polymer matrix is a paint, coating, resin, thermoset or thermoplastic.

12. Doped polymers according to any of claim 9, wherein said polymer matrix contains at least two types of thermotropic particles having different switching temperatures.

13. (canceled)

14. A paint comprising the thermotropic particles of claim 6.

15. A coating comprising the thermotropic particles of claims 6.

16. A resin comprising the thermotropic particles of claim 6.

17. A thermoset comprising the thermotropic particles of claim 6.

18. A thermoplastic comprising the thermotropic particles of claim 6.
